(19) United States
(12) Patent Application Publication
(10) Pub. No.: US 2013/0045382 A1
(43) Pub. Date: Feb. 21, 2013

(54) LIGHTWEIGHT X-RAY AND GAMMA RADIATION SHIELDING FIBERS AND COMPOSITIONS

(71) Applicants: David Dru HORINEK, Camarillo, CA (US); Max E. Foumberg, Calabasas, CA (US)

(72) Inventors: David Dru HORINEK, Camarillo, CA (US); Max E. Foumberg, Calabasas, CA (US)

(73) Assignee: Hologenix, LLC, Santa Monica, CA (US)

(21) Appl. No.: 13/572,371

(22) Filed: Aug. 10, 2012

Related U.S. Application Data
(60) Provisional application No. 61/522,088, filed on Aug. 10, 2011.

(51) Int. Cl. G21F 1/10; D01F 8/02; B32B 27/36; B32B 27/08; B32B 27/20; D01F 8/04; B32B 27/06

(52) U.S. Cl. 428/366; 252/478; 428/373; 428/419; 428/421; 428/422; 428/446; 428/450; 428/451; 428/457; 428/688; 428/702

(57) ABSTRACT

Described are improved x-ray and gamma ray radiation protective compositions, fibers, and clothing. Also described are methods for producing lightweight, radiation-shielding, protective textiles for protecting the human body and/or methods of producing radiation-shielding coating materials that can be used for coating textiles.

### REFERENCE TO RELATED APPLICATIONS

This application claims the benefit of U.S. Provisional Application No. 61/522,088, filed Aug. 10, 2011, the content of which is incorporated herein by reference.

### FIELD OF INVENTION

This invention relates to improved lightweight x-ray and gamma ray radiation protective compositions, fibers, and clothing. This invention also relates to methods for producing lightweight, radiation-shielding, protective textiles for protecting the human body and/or methods of producing radiation-shielding coating materials that can be used for coating textiles.

### BACKGROUND

People are exposed to heightened gamma and x-ray radiation during air travel, cancer treatments, or diagnostic x-rays. This gamma and x-ray radiation exposure can cause serious health risks, such as increasing the incidence of cancers. Despite public awareness of this problem, radiation exposure has continued, and will continue to be a health risk.

The earth is constantly being bombarded with cosmic radiation from the sun and other cosmic sources that result in x-ray and gamma radiation exposure. The amount of radiation that we are exposed to increases at higher altitudes and dramatically increases when we fly on commercial aircraft. See Robert Singleterry, Aircraft Radiation Shield Experiments—Preflight Laboratory Testing, NASA/TM-199-209131, (April 1999) <http://nac.alarc.nasa.gov/search.jsp?R=19990036754&qs=N%3D4294129243%2B4294 595384%2B4294455305>. Our exposure to x-ray and gamma radiation also increases with radiotherapy exposure. Accordingly, a need exists for lightweight materials that can shield the human body from x-ray and gamma radiation.

In the past, lead has commonly been used as in gamma and x-ray radiation shielding materials. However, due to their weight, inflexibility, and toxicity, lead materials are often not suitable for a lightweight gamma and x-ray radiation-attenuating textiles. Examples of materials including lead are provided, for example, in US Publication No. 2011/0198516 to Jiajin Fan et al.

Some non-lead containing gamma radiation shielding materials are also known. For example, U.S. Pat. No. 5,334,847 to Kronberg, describes gadolinium radiation shielding for attenuating gamma rays. Gadolinium has been used as a radiation shielding material in the past due to its alpha, beta, and gamma radiation absorbing behavior.

U.S. Pat. No. 6,166,390 to Quapp et al. describes a concrete radiation-shielding product. These concrete products include a gamma radiation-attenuating component. Examples of some gamma radiation-attenuating components include hydrogen and compounds of beryllium, boron, cadmium, hafnium, iridium, mercury, europium, gadolinium, samarium, dysprosium, erbium, and lutetium. These concrete materials again are not suitable for everyday personal protection from radiation.

U.S. Pat. No. 4,123,392 to William C. Hall et al, describes non-combustible gamma radiation shields. These gamma radiation shields are said to include gadolinium, samarium, europium, etc. because of their high thermal neutron cross-section.

### BRIEF DESCRIPTION OF THE DRAWINGS

FIG. 1 shows the chemical structure of Samarium (III) Oxide, Europium (III) Oxide, and Gadolinium (III) Oxide, according to embodiments of the invention.

FIG. 2 shows the chemical structure of a proanthocyadinin molecule according to embodiments of the invention.

FIG. 3 shows a bi-component radiation-shielding textile according to embodiments of the invention.

### SUMMARY OF THE INVENTION

The above issues of making a radiation shielding material that is lightweight and flexible enough for everyday personal protection are addressed. The inventors have found improved x-ray and gamma ray radiation protective compositions, fibers, and clothing. The inventors have also found methods for producing lightweight, radiation-shielding, protective textiles for protecting the human body and methods of producing radiation-shielding coating materials that can be used for, for example, for coating textiles, vehicles (aircrafts, spacecraft, etc.), or buildings (hangers, bunkers, etc).

One embodiment is a bi-component fiber. The bi-component fiber may include a first component (a sheath) and a second component (a core)—one or both of which can include radiation-shielding materials.

In some embodiments the first component (the sheath) of the bi-component fiber may include pigments in a polymer matrix to form a pigment filter. This pigment filter includes materials that selectively absorb visual light of certain wavelengths and pass or emit light in the range of 700-750 nm. The sheath is able to slow the oscillation of nuclear radiation due to the attenuation capabilities of a filter that is in the range of 700-750 nm. In addition or alternatively, the sheath also includes paramagnetic rock dust which has the ability to also slow the oscillation of nuclear radiation due to its ability to switch poles alternately from + to − field as it is exposed to radiation.

The second component (core) may be a polymeric composition including one or more radiation shielding compounds and/or isotopes of gadolinium (Gd), boron-10 (¹⁰B), samarium (Sm), and europium (Eu). Preferably, the polymeric composition includes compounds of two of gadolinium, boron, samarium, and europium. More preferably, the polymeric composition includes compounds and/or isotopes of gadolinium, boron, samarium, and europium. Preferably, the second layer includes “Gadoanthocyanidin,” which is a proanthocyanidin-doped gadolinium.

Preferably, the polymers used in the sheath and core layers may be known fiber polymers. For example, the fiber may include one or more of the following; Rayon, Acrylonitrile butadiene styrene (ABS), Acrylic (PMMA), Celluloid, Cellulose acetate, Cycloolefin Copolymer (COC), Ethylene-Vinyl Acetate (EVA), Ethylene vinyl alcohol (EVOH), Fluoroplastics (PTFE, alongside with FEP, PFA, CTFE, ECTFE, ETFE), Ionomers, KYDEX(a trademarked acrylic/PVC alloy), Liquid Crystal Polymer (LCP), Polyacetal (POM or Acetal), Polyacrylates (Acrylic), Polyacrylonitrile (PAN or Acrylonitrile), Polyamide (PA or Nylon), Polyamide-imide (PAI), Polyaryletherketone (PAEK or Ketone), Polybutadiene (PBD), Polybutylene (PB), Polybutylene terephthalate (PBT), Polycaprolactone (PCL), Polychlorotrifluoroethylene (PCTFE), Polyethylene terephthalate (PET), Polycyclohexylene dimethylene terephthalate (PCT), Polycarbonate (PC), Polyhydroxyalkanoates (PHAs), Polyketone (PK), Polyester, Polyethylene (PE), Polyetheretherketone (PEEK), Polyetherketoneketone (PEKK), Polyetherimide (PEI), Polyethersulfone (PES), Polyethylenechlorinates (PEC), Polyimide (PI), Polylactic acid (PLA), Polymethylpentene (PMP), Polyphenylene oxide (PPO), Polyphenylene sulfide (PPS), Polyphthalamide (PPA), Polystyrene (PS), Polysulfone (PSU), Polytrimethylene terephthalate (PTT), Polyurethane (PU), Polyvinyl acetate (PVA), Polyvinyl chloride (PVC), Polyvinylidene chloride (PVDC), and/or Styrene-acrylonitrile (SAN).

The sheath-core fibers are made according to known methods in the art. In some embodiments, extruding both the sheath and core together through spinneret orifices in sheath-core fashion produces the bi-component fiber. Other known methods of producing the sheath-core fibers, including coating a core fiber by passing the fiber through a polymer sheath solution, may also be used.

The fibers can be used to produce woven or non-woven textiles that can be used for radiation shielding. For example, the fibers can be used to produce clothing, or can be used anywhere radiation shielding is desired.

Another embodiment is a bi-component coating material. The bi-component coating material may include a first component (a skin layer) and a second component a (a core a base layer). The coating material may be applied to a variety of different substrates to afford radiation protection. In another embodiment, a laminate film can be produced including the disclosed sheath and core materials.

An embodiment of a bi-component fiber may include a sheath including pigments and polymer matrix, wherein the pigments selectively absorb visual light of certain wavelengths and pass or emit light in the range of 700-750 nm, and a core layer including gadolinium (Gd), boron-10 (¹⁰B), samarium (Sm), or europium (Eu) and a polymer matrix. The sheath may also include silicon (Si), iron (Fe), and magnesium (Mg), which may be present as paramagnetic rock dust.

In some embodiments, the core layer includes at least two or all of gadolinium (Gd), boron-10 (¹⁰B), samarium (Sm), and europium (Eu). The core layer may include samarium isotope ¹⁴⁹Sm and/or Gadoanthocyanidin. In some embodiments, the core layer may include Samarium (III) Oxide, Europium (III) Oxide, or Gadolinium (III) Oxide. Preferably, the core layer includes Gadoanthocyanidin and boron-10 (¹⁰B).

The polymer matrix may include one or more of Rayon, Acrylonitrile butadiene styrene, Acrylic, Celluloid, Cellulose acetate, Cycloolefin Copolymer, Ethylene-Vinyl Acetate, Ethylene vinyl alcohol, Fluoroplastics, lonomers, KYDEX, Liquid Crystal Polymer, Polyacetal, Polyacrylates, Polyacrylonitrile, Polyamide, Polyamide-imide, Polyaryletherketone, Polybutadiene, Polybutylene, Polybutylene terephthalate, Polycaprolactone, Polychlorotrifluoroethylene, Polyethylene terephthalate, Polycyclohexylene dimethylene terephthalate, Polycarbonate, Polyhydroxyalkanoates, Polyketone, Polyester, Polyethylene, Polyetheretherketone, Polyetherketoneketone, Polyetherimide, Polyethersulfone, Polyethylenechlorinates, Polyimide, Polylactic acid, Polymethylpentene, Polyphenylene oxide, Polyphenylene sulfide, Polyphthalamide, Polystyrene, Polysulfone, Polytrimethylene terephthalate, Polyurethane, Polyvinyl acetate, Polyvinyl chloride, Polyvinylidene chloride, and Styrene-acrylonitrile.

An embodiment of a bi-component coating material may include a skin layer including pigments, wherein the pigments selectively absorb visual light of certain wavelengths and pass or emit light in the range of 700-750 nm; and a core layer including gadolinium (Gd), boron-10 (¹⁰B), samarium (Sm), or europium (Eu).

In some embodiments, the skin layer may include silicon (Si), iron (Fe), and magnesium (Mg), which may be present as paramagnetic rock dust. In some embodiments, the core layer includes at least two or all of gadolinium (Gd), boron-10 (¹⁰B), samarium (Sm), and europium (Eu). The core layer may include samarium isotope ¹⁴⁹Sm and/or Gadoanthocyanidin. In some embodiments, the core layer may include Samarium (III) Oxide, Europium (III) Oxide, or Gadolinium (III) Oxide. Preferably, the core layer includes Gadoanthocyanidin and boron-10 (¹⁰B).

An embodiment of a bi-component film may include a skin layer including pigments, wherein the pigments selectively absorb visual light of certain wavelengths and pass or emit light in the range of 700-750 nm and a first polymer matrix; and a core layer comprising: a) gadolinium (Gd), boron-10 (¹⁰B), samarium (Sm), or europium (Eu); b) silicon (Si), iron (Fe), and magnesium (Mg); and c) a second polymer matrix.

In some embodiments, the core layer includes at least two or all of gadolinium (Gd), boron-10 (¹⁰B), samarium (Sm), and europium (Eu). The core layer may include samarium isotope ¹⁴⁹Sm and/or Gadoanthocyanidin. In some embodiments, the core layer may include Samarium (III) Oxide, Europium (III) Oxide, or Gadolinium (III) Oxide. Preferably, the core layer includes Gadoanthocyanidin and boron-10 (¹⁰B).

The first and second polymer matrix may each include one or more of Rayon, Acrylonitrile butadiene styrene, Acrylic, Celluloid, Cellulose acetate, Cycloolefin Copolymer, Ethylene-Vinyl Acetate, Ethylene vinyl alcohol, Fluoroplastics, Ionomers, KYDEX, Liquid Crystal Polymer, Polyacetal, Polyacrylates, Polyacrylonitrile, Polyamide, Polyamide-imide, Polyaryletherketone, Polybutadiene, Polybutylene, Polybutylene terephthalate, Polycaprolactone, Polychlorotrifluoroethylene, Polyethylene terephthalate, Polycyclohexylene dimethylene terephthalate, Polycarbonate, Polyhydroxyalkanoates, Polyketone, Polyester, Polyethylene, Polyetheretherketone, Polyetherketoneketone, Polyetherimide, Polyethersulfone, Polyethylenechlorinates, Polyimide, Polylactic acid, Polymethylpentene, Polyphenylene oxide, Polyphenylene sulfide, Polyphthalamide, Polystyrene, Polysulfone, Polytrimethylene terephthalate, Polyurethane, Polyvinyl acetate, Polyvinyl chloride, Polyvinylidene chloride, and Styrene-acrylonitrile.

An embodiment of a mono-component fiber includes pigments that selectively absorb visual light of certain wavelengths and pass or emit light in the range of 700-750 nm; gadolinium (Gd), boron-10 (¹⁰B), samarium (Sm), europium or (Eu); silicon (Si), iron (Fe), and magnesium (Mg); and a polymer matrix.

In some embodiments, the mono-component fiber may include at least two of gadolinium (Gd), boron-10 (¹⁰B), samarium (Sm), and europium (Eu). The mono-component fiber may include samarium isotope ¹⁴⁹Sm. The mono-component fiber may include Samarium (III) Oxide, Europium (III) Oxide, and/or Gadolinium (III) Oxide. The mono-component fiber may include Gadoanthocyanidin. The mono-component fiber may include Gadoanthocyanidin and boron-10 (¹⁰B) in some embodiments.

The polymer matrix may include one or more of Rayon, Acrylonitrile butadiene styrene, Acrylic, Celluloid, Cellulose acetate, Cycloolefin Copolymer, Ethylene-Vinyl Acetate, Ethylene vinyl alcohol, Fluoroplastics, Ionomers, KYDEX, Liquid Crystal Polymer, Polyacetal, Polyacrylates, Polyacrylonitrile, Polyamide, Polyamide-imide, Polyaryletherketone, Polybutadiene, Polybutylene, Polybutylene terephthalate, Polycaprolactone, Polychlorotrifluoroethylene, Polyethylene terephthalate, Polycyclohexylene dimethylene terephthalate, Polycarbonate, Polyhydroxyalkanoates, Polyketone, Polyester, Polyethylene, Polyetheretherketone, Polyetherketoneketone, Polyetherimide, Polyethersulfone, Polyethylenechlorinates, Polyimide, Polylactic acid, Polymethylpentene, Polyphenylene oxide, Polyphenylene sulfide, Polyphthalamide, Polystyrene, Polysulfone, Polytrimethylene terephthalate, Polyurethane, Polyvinyl acetate, Polyvinyl chloride, Polyvinylidene chloride, and Styrene-acrylonitrile.

### DETAILED DESCRIPTION

Described are improved x-ray and gamma ray radiation protective compositions, fibers, and clothing. Also described are methods for producing lightweight, radiation-shielding, protective textiles for protecting the human body and/or methods of producing radiation-shielding coating materials that can be used for coating textiles, vehicles (aircrafts, spacecraft, etc.), and buildings (hangers, bunkers, etc.).

The protective articles include one or more layers. Preferably, the protective articles include at least two layers: a sheath or skin layer and a core layer. The sheath or skin layer may be the first line of defense against radiation. This layer attenuates the radiation presented to it. The core, which is loaded with neutron absorbing elements, absorbs and further alters the radiation.

The first layer is a sheath or skin layer that includes pigments in a polymer matrix to form a pigment filter. This pigment filter includes materials that selectively absorb light of certain wavelengths and pass or emit light in the range of 700-750 nm. The sheath is able to slow the oscillation of nuclear radiation due to the attenuation capabilities of a filter that is in the range of 700-750 nm.

Preferably, the sheath or skin layer includes silicon (Si), iron (Fe), and magnesium (Mg). One such composition is paramagnetic rock dust. Paramagnetic rock dust has been examined at the University of Vienna under a micropolariscope. The rock dust showed an alteration of the atomic lattice with a regression to orthoclase. This generated an electrical potential that changes its polarity each time it is emitted, thus producing plus and minus electricity alternately. Moreover, it was discovered that the mineral product has a positive pole. It also has been shown to have a cell membrane-stimulating magnetic pulsation termed DIN OD 144. It breaks down the high oscillation rate of such particles, thus rendering them innocuous. The Russian Institute of Atomic Physics in Ukraine has also confirmed this effect. Paramagnetic rock dust can be obtained commercially. Pigments that absorb visual light of certain wavelengths and pass visual light in the range of 700-750 nm may be added to the paramagnetic rock dust.

Preferably, the first layer includes the paramagnetic rock dust and/or pigments in a polymer matrix. The polymer matrix can include any known polymers depending upon the end use of the shielding. Preferably, this polymer does not significantly interfere with the light filtering and/or paramagnetic abilities of the paramagnetic rock dust and/or pigments. In preferred embodiments, the first layer may include polyethylene terephthalate.

The second layer, the core layer of the fiber, coating, or film may be a polymeric composition including one or more radiation shielding compounds of gadolinium (Gd), boron-10 (¹⁰B), samarium (Sm), and europium (Eu). Preferably, the polymeric composition includes compounds including two of gadolinium, boron-10, samarium, and europium. More preferably, the polymeric composition includes compounds including gadolinium, samarium, and europium. Preferably, the second layer includes the samarium isotope ¹⁴⁹Sm.

Lead, which is one of the most commonly used elements for nuclear shielding materials, has a neutron cross-section (NCS) of 0.171 barns/mol. In comparison, gadolinium has a NCS of 49,000 barns/mol−2.8×105 times larger than lead. In addition, gadolinium isotope (¹⁵⁷Gd) has a NCS that is 259,000 barns/mol, which equates to being 1.5×106 times larger than lead. These higher NCS values mean that less gadolinium is required to provide the same radiation shielding as compared to lead. Samarium has a NCS of 5,900 barns/mol, which is 3.4×105 larger than lead. Further, its isotope ¹⁴⁹Sm has a NCS value of 42,080 barns/mol which is 2.4×105 larger than lead. This means that less samarium is required to provide the same radiation affect compared to lead. Further, Europium has a NCS of 4,600 barns/mol which is 2.6×104 and its isotope ¹⁵¹Eu has a NCS of 9,100 barns, which is 5.3×104 larger than lead.

By using gadolinium, boron-10, samarium, and europium instead or in addition to lead the described shielding materials can be lighter and significantly more effective than older radiation shielding.

In some embodiments the gadolinium, samarium, and europium (Eu) are obtained from a calcium montmorillonite clay includes a relatively high percentage of these elements. A preferred Example of such a product is ECELERITE, which can be obtained from US Rare Earth Minerals, Inc. The Fuller's Earth product can be supplemented with additional compounds including gadolinium, samarium, and/or europium.

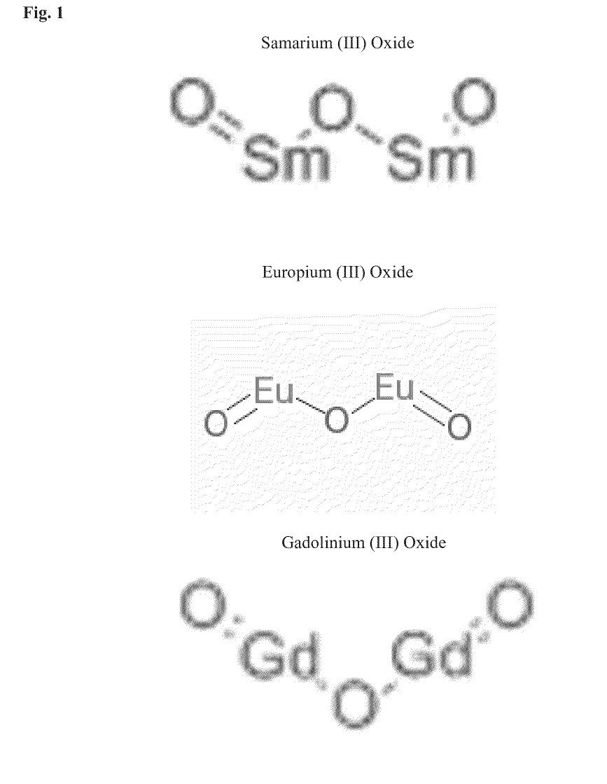

Preferably, the second layer includes gadolinium, samarium, and/or europium in their oxide form. FIG. 1 shows the chemical structure of Samarium (III) Oxide, Europium (III) Oxide, Gadolinium (III) Oxide, according to embodiments of the invention.

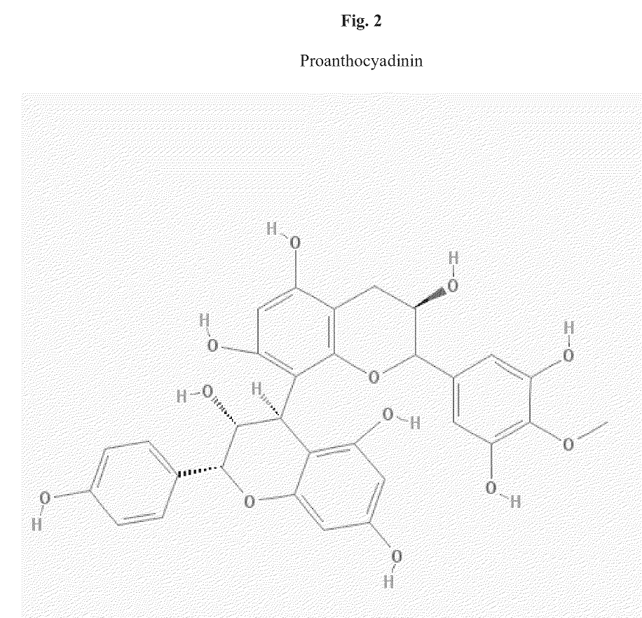

Preferably, the second layer includes “Gadoanthocyanidin.” Gadoanthocyanidin is proanthocyanidin-doped gadolinium. Proanthocyanidins belong to a class of polyphenols and are essentially polymer chains of flavonoids. These compounds of gadolinium have been shown to provide exception radiation shielding capabilities. These compounds can be produced, for example, by heating a mixture containing proanthocyanidins and gadolinium to break the hydrogen bonds in the proanthocyanidin molecule, and allowing gadolinium to bond to the terminal oxygen molecules. FIG. 2 shows a proanthocyadinin molecule including the terminal hydrogen bonds.

Preferably, the second layer or core layer includes the gadolinium (Gd), samarium (Sm), boron-10 (¹⁰B), and/or europium compounds in a polymer matrix. The polymer matrix can include the same polymer or a different polymer than the first layer depending upon the end use of the shielding. Preferably, this polymer does not significantly interfere with the shielding effects of the second layer. In some embodiments, the second layer may include polyester polymer, for example polyethylene terephthalate.

The sheath-core fibers may be made according to known methods in the art. In some embodiments the bi-component fiber is produced by extruding both the sheath and core together through spinneret orifices in sheath-core fashion. Other known methods of producing the sheath-core fibers, including coating a core fiber by passing the fiber through a polymer sheath solution, may also be used.

The fibers can be used to produce woven or non-woven textiles that can be used for radiation shielding. For example, the fibers can be used to produce clothing, or can be used anywhere radiation shielding is desired.

Another embodiment is a bi-component coating material. The bi-component coating material may include a first component (a skin layer) and a second component a (a core a base layer). The coating material may be applied to a variety of different substrates to afford radiation protection. The first component may again include pigments in a polymer matrix to form a pigment filter and/or paramagnetic rock dust. This pigment filter includes materials that selectively absorb all wavelengths of light except those that are 700-750 nm.

The second component (core) may be a polymeric composition comprising one or more radiation shielding compounds of gadolinium (Gd), samarium (Sm), and europium (Eu). Preferably, the polymeric composition includes compounds of two of gadolinium, samarium, and europium. More preferably, the polymeric composition includes compounds of gadolinium, samarium, and europium.

In another embodiment, a laminate film can be produced including the disclosed sheath and core materials. In this embodiment, the sheath and core layers of the film may be produced, for example, by co-extruding the two layers through a die to produce a multi-layer laminate film. Alternatively, the sheath material can be sprayed or otherwise applied onto a previously formed core layer.

In some embodiments, the components of the sheath layer and core layer and be combined together in a single layer to produce a mono-layer fiber, film, coating etc.

Preferably, materials produced from the above described components are able to attenuate at least 20%, more preferably at least 25% even more preferably at least 35% of the gamma radiation emitted from a Cs-137 source as described in Example 2.

This invention will be better understood with reference to the following example, which is intended to illustrate specific embodiments within the overall scope of the invention.

### EXAMPLE 1

### Lightweight Radiation-shielding Fiber Composition:

Preparation for “Gadoanthocyanidin” (proanthocyanidin doped gadolinium):

Step 1: Soak one-part saffron “Crocus sativus” in two parts 100% ethanol for 24 hours.

Step 2: Saffron is found in decant, and proanthocyanidin remains in ethanol as solution “A.” Proanthocyanidin is thus dehydrated.

Step 3: Gadolinium (III) Oxide is mixed into solution “A” and left to sit in solution “A” for 24 hours.

Step 4: Gadolinium is separated from solution “A” by use of a strainer. Step 5: Heat is applied to break any remaining hydrogen bonds on the proanthocyanidin molecule, and allowing gadolinium to bond to the terminal oxygen molecules. Thus forming a newly doped form of gadolinium, “Gadoanthocyanidin”

Additional powders for core and sheath layers:

Powder “A” is preferably a calcium montmorillonite clay.

Powder B preferably contains 30-50% gadolinium including but not limited to gadolinium (III) oxide (Gd₂O₃) and/or ¹⁵⁷Gd₂O₃ (of that 30-50%, 33% is doped with proanthocyanidin as Gadoanthocyanidin), 30-50% boron-10 carbide (¹⁰B₄C) 15% samarium including but not limited to samarium (III) oxide (Sm₂O₃) and/or 149Sm₂O₃, and 5% europium including but not limited to Europium (III) Oxide (Eu₂O₃) and/or ¹⁵¹Eu₂O₃. These preferred compounds may be obtained through any isotope and/or any lanthanide supplier (for example: Oak Ridge National Laboratory National Isotope Development Center at http://www.ornl.gov/).

Powder “D” preferably contains the following composition: 30% orthoclase (also referred to as potassium feldspar), 20-30% plagioclase feldspar, 20-30% quartz, 15-20% biotite, 5-10% disthene, garnet and sillimanite, as well as trace amounts of iron, zircon and rutile. This composition is milled with an “air jet attrition mill” and classified with a Microtrac particle size analyzer. Preferably, this powder has a maximum particle size of 2μ; to insure maximum surface area coverage.

The core includes 90-95% powder “A” and 5-10% powder “B”. A “pre-masterbatch” (powder “A” and powder “B”) is mixed in a 5:1 ratio (5 parts polymer: 1 part powder) to create a master batch. After mixing the powder with the melted polymer, the composite is extruded, cooled, and chopped into 1.125 inch chips as “master batch 1”.

The sheath includes 99% polymer, 0.5% pigment (with spectral emission of 700-750 nm), and 0.5% paramagnetic rock powder “D”. The sheath masterbatch is made by mixing 0.5% pigment and 0.5% paramagnetic rock powder “D” with 99% polymer. After mixing the powder with melted polymer, the mixture extruded, cooled, and chopped into 1.125 inch chips as “master batch 2”.

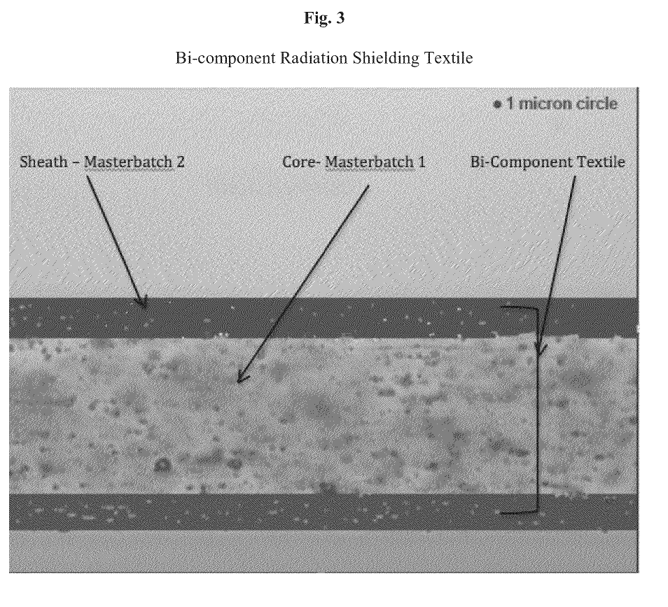

A bi-component filament yarn is then produced by extruding a core fiber and then passing this core fiber through a molten bath containing a polymer sheath solution. FIG. 3 shows a resulting bi-component radiation shielding textile.

### EXAMPLE 2

To test the radiation shielding abilities of the above described materials, the following structure was created and tested.

Materials—A structure was created using the following materials: Polyethylene Terephthalate sheets cut into multiple 4×4 squares Gadolinium Oxide (Gd3O2) mixed with ELMER'S and/or 3M spray adhesive 3.0 mm thick Magenta film sheets made of polyethylene terephthalate cut into multiple 4×4 squares

Method of creating the layered structure for testing:
1. The P.E.T. squares were cut into multiple pieces.
2. Each square is sprayed with ELMER'S and/or 3M spray adhesive.
3. Gadolinim oxide is sifted onto adhesive layer and then sprayed again with Elmer's and/or 3M spray adhesive
4. The P.E.T. square is placed over the gadolinium oxide spray adhesive layer (Gadolinium Oxide is sandwiched in by the P.E.T. squares).
5. Step 4 is done for multiple layers until the sample thickness reaches around ¼ inch thick.
6. Each magenta film square is sprayed with ELMER'S and/or 3M spray adhesive.
7. Gadolinim oxide is sifted onto the adhesive layer and then sprayed again with ELMERS'S and/or 3M spray adhesive.
8. The magenta film square is placed over the gadolinium oxide spray adhesive layer (Gadolinium Oxide is sandwiched in by the magenta film squares).
9. A few layers of gadolinium oxide magenta film is then placed and adhered to the top and bottom faces of the P.E.T Gadolinium oxide sandwich (from step 5) until the thickness is around ⅜ to ½ inch thick
10. The sample was placed into a polyethylene terephthalate ziploc bag to keep it safe from contaminants during shipping and to help keep the sample in one piece.

Testing:

A high sensitivity Geiger counter (Thermo scientific FH 40 G-10) was used for testing. The Geiger counter was set at a distance equal to the thickness of the material, from a Cs-137 source (0.25 μCi), the material being set right in front of the Geiger measuring spot. Previous experiments on similar materials showed that it is useless to run measurement with a greater distance between the source and the detector. The Geiger counter registers impact as nSv/h. Conversion from μCi to nSv/h is not straightforward. One is the total radiation emitted by the source (1 μCi=3.7.104 disintegrations per second) whereas the second is the registered emission (as a dose). However, the aim of the study being to evaluate a ratio between the dose received with and without the material, conversion is of no relevance.

Results:
Background level: 140 to 150 nSv/h

| Sample | Distance from source (cm) | Result (μSv/h) |
|---|---|---|
| Without film structure | 0.4 | 1.241.42 |
| With film structure | 0.4 | 1.091.22 |

### CONCLUSION

The film structure attenuated 37.8% of the gamma radiation emitted from the Cs-137 source.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A bi-component fiber comprising:
a sheath comprising pigments and polymer matrix, wherein the pigments selectively absorb visual light of certain wavelengths and pass or emit light in the range of 700-750 nm; and
a core layer comprising gadolinium (Gd), boron-10 (¹⁰B), samarium (Sm), or europium (Eu) and a polymer matrix.

2. The bi-component fiber of claim 1, wherein the sheath further comprises silicon (Si), iron (Fe), and magnesium (Mg).

3. The bi-component fiber of claim 1, wherein the core layer comprises at least two of gadolinium (Gd), boron-10 (¹⁰B), samarium (Sm), and europium (Eu).

4. The bi-component fiber of claim 1, wherein the core layer comprises samarium isotope ¹⁴⁹Sm.

5. The bi-component fiber of claim 1, wherein the core layer comprises Samarium (III) Oxide, Europium (III) Oxide, or Gadolinium (III) Oxide.

6. The bi-component fiber of claim 1, wherein the core layer comprises Gadoanthocyanidin.

7. The bi-component fiber of claim 1, wherein the core layer comprises Gadoanthocyanidin and boron-10 (¹⁰B).

8. The bi-component fiber of claim 1, wherein the polymer matrix comprises one or more of Rayon, Acrylonitrile butadiene styrene, Acrylic, Celluloid, Cellulose acetate, Cycloolefin Copolymer, Ethylene-Vinyl Acetate, Ethylene vinyl alcohol, Fluoroplastics, Ionomers, KYDEX, Liquid Crystal Polymer, Polyacetal, Polyacrylates, Polyacrylonitrile, Polyamide, Polyamide-imide, Polyaryletherketone, Polybutadiene, Polybutylene, Polybutylene terephthalate, Polycaprolactone, Polychlorotrifluoroethylene, Polyethylene terephthalate, Polycyclohexylene dimethylene terephthalate, Polycarbonate, Polyhydroxyalkanoates, Polyketone, Polyester, Polyethylene, Polyetheretherketone, Polyetherketoneketone, Polyetherimide, Polyethersulfone, Polyethylenechlorinates, Polyimide, Polylactic acid, Polymethylpentene, Polyphenylene oxide, Polyphenylene sulfide, Polyphthalamide, Polystyrene, Polysulfone, Polytrimethylene terephthalate, Polyurethane, Polyvinyl acetate, Polyvinyl chloride, Polyvinylidene chloride, and Styrene-acrylonitrile.

9. A bi-component coating material comprising:
a skin layer comprising pigments, wherein the pigments selectively absorb visual light of certain wavelengths and pass or emit light in the range of 700-750 nm; and
a core layer comprising gadolinium (Gd), boron-10 (¹⁰B), samarium (Sm), or europium (Eu).

10. The bi-component coating material of claim 9, wherein the skin layer comprises silicon (Si), iron (Fe), and magnesium (Mg).

11. The bi-component coating material of claim 9, wherein the core layer comprises at least two of gadolinium (Gd), boron-10 (¹⁰B), samarium (Sm), and europium (Eu).

12. The bi-component coating material of claim 9, wherein the core layer comprises samarium isotope ¹⁴⁹Sm.

13. The bi-component coating material of claim 9, wherein the core layer comprises Samarium (III) Oxide, Europium (III) Oxide, or Gadolinium (III) Oxide.

14. The bi-component coating material of claim 9, wherein the core layer comprises Gadoanthocyanidin.

15. The bi-component coating material of claim 9, wherein the core layer comprises Gadoanthocyanidin and boron-10 (¹⁰B).

16. A bi-component film comprising:
a skin layer comprising pigments, wherein the pigments selectively absorb visual light of certain wavelengths and pass or emit light in the range of 700-750 nm and a first polymer matrix; and
a core layer comprising: a) gadolinium (Gd), boron-10 (¹⁰B), samarium (Sm), or europium (Eu); b) silicon (Si), iron (Fe), and magnesium (Mg); and c) a second polymer matrix.

17. The bi-component film of claim 16, wherein the core layer comprises at least two of gadolinium (Gd), boron-10 (¹⁰B), samarium (Sm), and europium (Eu).

18. The bi-component film of claim 16, wherein the core layer comprises samarium isotope ¹⁴⁹Sm.

19. The bi-component film of claim 16, wherein the core layer comprises Samarium (III) Oxide, Europium (III) Oxide, or Gadolinium (III) Oxide.

20. The bi-component film of claim 16, wherein the core layer comprises Gadoanthocyanidin.

21. The bi-component film of claim 16, wherein the core layer comprises Gadoanthocyanidin and boron-10 (¹⁰B).

22. The bi-component film of claim 16, wherein the first and second polymer matrix each comprise one or more of Rayon, Acrylonitrile butadiene styrene, Acrylic, Celluloid, Cellulose acetate, Cycloolefin Copolymer, Ethylene-Vinyl Acetate, Ethylene vinyl alcohol, Fluoroplastics, Ionomers, KYDEX, Liquid Crystal Polymer, Polyacetal, Polyacrylates, Polyacrylonitrile, Polyamide, Polyamide-imide, Polyaryletherketone, Polybutadiene, Polybutylene, Polybutylene terephthalate, Polycaprolactone, Polychlorotrifluoroethylene, Polyethylene terephthalate, Polycyclohexylene dimethylene terephthalate, Polycarbonate, Polyhydroxyalkanoates, Polyketone, Polyester, Polyethylene, Polyetheretherketone, Polyetherketoneketone, Polyetherimide, Polyethersulfone, Polyethylenechlorinates, Polyimide, Polylactic acid, Polymethylpentene, Polyphenylene oxide, Polyphenylene sulfide, Polyphthalamide, Polystyrene, Polysulfone, Polytrimethylene terephthalate, Polyurethane, Polyvinyl acetate, Polyvinyl chloride, Polyvinylidene chloride, and Styrene-acrylonitrile.

23. A mono-component fiber comprising:
pigments that selectively absorb visual light of certain wavelengths and pass or emit light in the range of 700-750 nm;
gadolinium (Gd), boron-10 (¹⁰B), samarium (Sm), europium or (Eu);
silicon (Si), iron (Fe), and magnesium (Mg); and
a polymer matrix.

24. The mono-component fiber of claim 23, comprising at least two of gadolinium (Gd), boron-10 (¹⁰B), samarium (Sm), and europium (Eu).

25. The mono-component fiber of claim 23, comprising samarium isotope ¹⁴⁹Sm.

26. The mono-component fiber of claim 23, comprising Samarium (III) Oxide, Europium (III) Oxide, or Gadolinium (III) Oxide.

27. The mono-component fiber of claim 23, comprising Gadoanthocyanidin.

28. The mono-component fiber of claim 23, comprising Gadoanthocyanidin and boron-10 (¹⁰B).

29. The mono-component fiber of claim 23, wherein the polymer matrix comprises one or more of Rayon, Acrylonitrile butadiene styrene, Acrylic, Celluloid, Cellulose acetate, Cycloolefin Copolymer, Ethylene-Vinyl Acetate, Ethylene vinyl alcohol, Fluoroplastics, Ionomers, KYDEX, Liquid Crystal Polymer, Polyacetal, Polyacrylates, Polyacrylonitrile, Polyamide, Polyamide-imide, Polyaryletherketone, Polybutadiene, Polybutylene, Polybutylene terephthalate, Polycaprolactone, Polychlorotrifluoroethylene, Polyethylene terephthalate, Polycyclohexylene dimethylene terephthalate, Polycarbonate, Polyhydroxyalkanoates, Polyketone, Polyester, Polyethylene, Polyetheretherketone, Polyetherketoneketone, Polyetherimide, Polyethersulfone, Polyethylenechlorinates, Polyimide, Polylactic acid, Polymethylpentene, Polyphenylene oxide, Polyphenylene sulfide, Polyphthalamide, Polystyrene, Polysulfone, Polytrimethylene terephthalate, Polyurethane, Polyvinyl acetate, Polyvinyl chloride, Polyvinylidene chloride, and Styrene-acrylonitrile.
